(19) United States
(12) Patent Application Publication
(10) Pub. No.: US 2010/0087947 A1
(43) Pub. Date: Apr. 8, 2010

(54) ELECTRIC CONTROL DEVICE IN AN ENGRAVING MARCHINE WITH A USB INTERFACE

(76) Inventor: Bor-Yann CHUANG, Taiping City (TW)

Correspondence Address: Bor-Yann Chuang, No.78, Yungfeng Rd., Taiping City, Taichung County, TW

(21) Appl. No.: 12/246,933

(22) Filed: Oct. 7, 2008

(51) Int. Cl. G05B 19/18

(52) U.S. Cl. 700/164

(57) ABSTRACT

An electric control device in an engraving machine with a USB interface is provided, in which the engraving machine is provided with a platform. A cutting tool positioning mechanism is on the platform. A cutting tool is arranged in the cutting tool positioning mechanism and provided with a motor driving the cutting tool to revolve to engrave. An electric control device is further provided in the platform of engraving machine. The electric control device is powered and driven by a power supply unit and comprises a USB data access unit with a USB port, a control unit connected to the data access unit to drive the cutting tool positioning mechanism, a display unit driven by the control unit to show various messages, and a setting unit connected to the control unit and allowing settings and command input. Programming data portability and storage capability increases for achievement of convenience in use.

### BACKGROUND OF THE INVENTION

1. Field of the Invention

This invention relates to an electric control device in an engraving machine with a USB interface.

2. Description of the Related Art

A conventional electric control device in an engraving machine transmits data stored in a computer through a transmission line mostly by using a RS-232 interface. However, in the modern technology, USB is widely used almost in all families and is thus of catholicity. There is more comparatively trouble in using RS-232. A computer is nowadays provided with a USB port, and thus a USB-interfaced flash drive where the data is stored supports plug and play and is featured with high portability and easy use. Thus, improvement of the conventional electric engraving-machine control device is necessarily made.

Consequently, because of the technical defects of described above, the applicant keeps on carving unflaggingly through wholehearted experience and research to develop the present invention, which can effectively improve the defects described above.

### SUMMARY OF THE INVENTION

An electric control device in an engraving machine with a USB interface is provided in this invention, in which the engraving machine is provided with a platform. A cutting tool positioning mechanism is provided on the platform. A cutting tool is arranged in the cutting tool positioning mechanism and provided with a motor, and the motor drives the cutting tool to revolve to engrave. An electric control device is further provided in the platform of engraving machine. The electric control device is powered and driven by a power supply unit and comprises a USB-interfaced data access unit provided with a USB port, a control unit connected to the data access unit to drive the cutting tool positioning mechanism, a display unit driven by the control unit to show various messages, and a setting unit that is connected to the control unit and allows settings and command input. Thus, programming data portability and storage capability increases for achievement of convenience in use.

### BRIEF DESCRIPTION OF THE DRAWINGS

FIG. 1 is a 3D view of an engraving machine according to this invention; and

FIG. 2 is a block diagram of an electric control device provided in the engraving machine according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

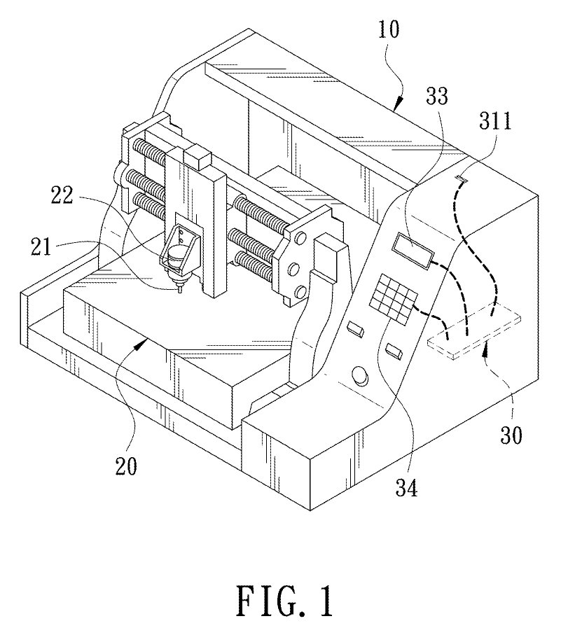

With reference to FIG. 1 shown as a 3D view of an engraving machine according to this invention, the engraving machine is provided with a platform 10. A cutting tool positioning mechanism 20 is provided on the platform 10. A cutting tool 21 is arranged in the cutting tool positioning mechanism 20 and provided with a motor 22, and the motor 22 drives the cutting tool 21 to revolve to engrave. In a preferred embodiment of this invention, the cutting tool positioning mechanism 20 is driven by three servomotors (not shown) to move to three axes (X, Y, and Z) separately for positioning. An electric control device 30 is further provided in the platform 10.

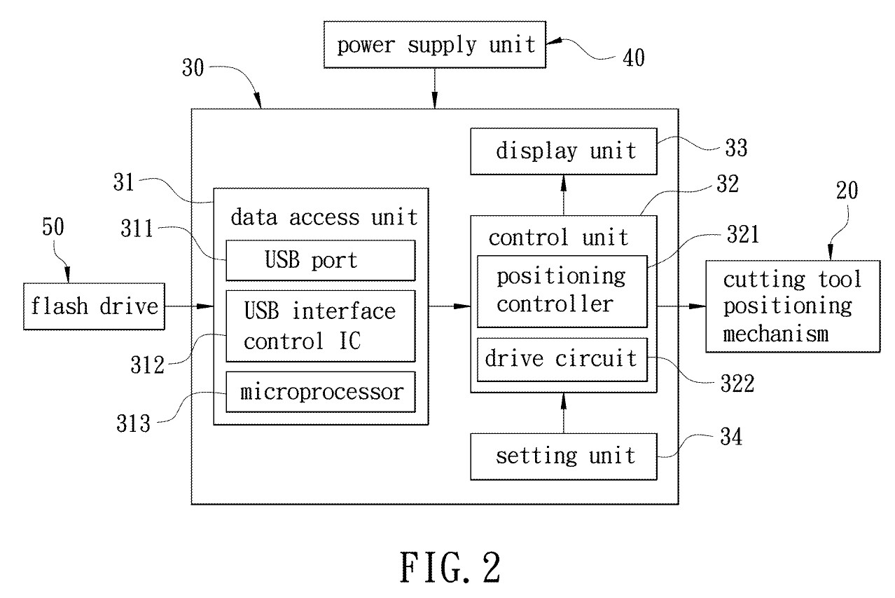

With reference to FIG. 2 shown as a block diagram of the electric control device provided in the engraving machine according to this invention, the electric control device 30 is powered and then driven by a power supply unit 40. In the preferred embodiment of this invention, the power supply unit 40 is a switching power. The electric control device 30 comprises a data access unit 31, a control unit 32, a display unit 33, and a setting unit 34.

The data access unit 31 is a USB (Universal Serial Bus) interface. The housing of platform 10 is formed with a USB port 311 into which a flash drive 50 is inserted for data access. In the preferred embodiment of this invention, the data access unit 31 is provided with a USB interface control IC 312 and further comprises a microprocessor 313. The microprocessor 313 comprises a memory provided for a buffer interface.

One terminal of the control unit 32 is connected to the data access unit 31 and the other terminal is connected to the cutting tool positioning mechanism 20 to read and convert the data in the data access unit 31 for further driving the cutting tool positioning mechanism 20. In the preferred embodiment of this invention, the control unit 32 comprises a positioning controller 321 and a drive circuit 322. The positioning controller 321 is a FPGA IC (Field Programmable Gate Array, FPGA IC) that receives the data in the data access unit 31 and then outputs it to the drive circuit 322, and then the drive circuit 322 converts it into a pulse signal that drives the cutting tool positioning mechanism 20 to drive the cutting tool 21 to move in the directions of 3 axes for positioning.

The display unit 33 is provided on the housing of platform 10 and thus connected to the control unit 32 to show various messages. In the preferred embodiment of this invention, the display unit 33 is provided with a display.

The setting unit 34 is provided on the housing of platform 10 and thus connected to the control unit 32 and allows setting and command input for controlling the control unit 32. In the preferred embodiment of this invention, the setting unit 34 is provided with several keys for manual zero point setting and command input. The setting unit 34 is used to manually select a system file to be operated. The control unit 32 is used to read the data in the data access unit 31.

With reference to FIG. 2 shown as a block diagram of the electric control device provided in the engraving machine according to this invention, the electric control device 30 is powered and then driven by a power supply unit 40. The data access unit 31 is provided with the USB port 311 into which the flash drive 50 is inserted, and thus the data in the flash drive is transmitted to the microprocessor 313 of the data access unit 31 and meanwhile connected to the control unit 32 to further drive. The control unit 32 synchronously drives the display unit 33, the setting unit 34, and the cutting tool positioning mechanism 20, and thus the data in the microprocessor 313 is shown on the display unit 33. The keys of setting unit 34 are even pressed to manually input commands for selecting the data file to be operated, and setting up the zero point. Further, the control unit 32 is made to read the data in the microprocessor 313 and convert it into several stepping pulse signals, thereby driving the cutting tool positioning mechanism 20 to shift in the directions of three axes for achievement of positioning and 3D engraving. Thus, programming data portability and storage capability increases for achievement of convenience in use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electric control device in an engraving machine with a USB interface, in which the engraving machine is provided with a platform, a cutting tool positioning mechanism is provided on the platform, a cutting tool is arranged in the cutting tool positioning mechanism and provided with a motor, and the motor drives the cutting tool to revolve to engrave, an electric control device is further provided in the platform, and the electric control device is powered and driven by a power supply unit and comprises:
a data access unit that is interfaced in a USB (Universal Serial Bus), in which a USB port into which a flash drive is inserted for data access is formed on the housing of platform;
a control unit one terminal of which is connected to the data access unit and the other terminal of which is connected to the cutting tool positioning mechanism to read and convert the data in the data access unit for further driving the cutting tool positioning mechanism;
a display unit provided on the housing of platform and thus connected to the control unit to show various messages; and
a setting unit provided on the housing of platform and thus connected to the control unit and allows setting and command input for controlling the control unit.

2. The electric control device in the engraving machine with the USB interface according to claim 1, wherein the data access unit further comprises a USB interface control IC and a microprocessor and the microprocessor comprises a memory provided for a buffer interface.

3. The electric control device in the engraving machine with the USB interface according to claim 1, wherein the control unit comprises a positioning controller and a drive circuit, the positioning controller is a FPGA IC (Field Programmable Gate Array, FPGA IC) that receives the data in the data access unit and then outputs it to the drive circuit, and then the drive circuit converts it into a pulse signal that drives the cutting tool positioning mechanism to drive the cutting tool to shift in the directions of 3 axes for positioning.

4. The electric control device in the engraving machine with the USB interface according to claim 1, wherein the display unit is a display.

5. The electric control device in the engraving machine with the USB interface according to claim 1, wherein the setting unit is formed with several keys.
